(19) United States
(12) Patent Application Publication
(10) Pub. No.: US 2024/0337802 A1
(43) Pub. Date: Oct. 10, 2024

(54) FIBER OPTIC CLOSURE AND ORGANIZER ASSEMBLY

(71) Applicants: David WITTMEIER, Duncan, SC (US); Will MILLER, Duncan, SC (US); Vahid EBRAHIMI, Duncan, SC (US); AFL Telecommunications LLC, Duncan, SC (US)

(72) Inventors: David Wittmeier, Greer, SC (US); Will Miller, Easley, SC (US); Vahid Ebrahimi, Simpsonville, SC (US)

(21) Appl. No.: 18/293,047

(22) PCT Filed: Jul. 29, 2022
(86) PCT No.: PCT/US2022/038896

§ 371 Date: Jan. 29, 2024

Related U.S. Application Data
(60) Provisional application No. 63/227,031, filed on Jul. 29, 2021.

(51) Int. Cl. G02B 6/44

(52) U.S. Cl. CPC G02B 6/445; G02B 6/4454; G02B 6/4455

(57) ABSTRACT

A fiber optic closure is provided, the closure including a plurality of sidewalls extending along a longitudinal axis between a first end and a second end. The first end forms an open end such that a cable is extendable to or from an interior formed by the plurality of sidewalls. The closure includes a base wall extending from the plurality of sidewalls along the longitudinal axis and a lateral axis and an end wall extending along the lateral axis between the plurality of sidewalls. A bracket assembly extends along a transverse axis. The bracket assembly includes a main body and a plurality of hinge assemblies. The plurality of hinge assemblies is spaced apart in a linear array along the transverse axis. The main body is angled at 45 degrees or greater between a transverse axis and a longitudinal axis.

### FIELD

The present disclosure relates generally to closures, such as for fiber optic cable connections, and more specifically to improved organizer assemblies for fiber optic closures.

### BACKGROUND

Certain closures are utilized in outdoor environments to facilitate the connection of transmission cables such as fiber optic cables. Such closures may include “butt” closures or “domed” closures for fiber optic cable connections. The cables enter the closure through a sealed base, and connection of the cable elements occurs within the closure. In the case of fiber optic cables, spliced-together optical fibers are held within the closure.

Many fiber organizer assemblies utilized in known closures generally have edges that can cause buffer tubes to kink if they are pulled over these edges. Further, in many cases, trays of the organizer assemblies must be held in the vertical or up position while other trays are being populated with fiber and while splicing is being done. Still further, splice modules utilized in such trays provide limited flexibility with respect to the types of splices and/or other components that can be held therein.

Structures and methods for preparing trays for splicing and storing trays and other internal surfaces of closures may provide some degree of cable and fiber organization but fail to mitigate, or inadequately mitigate, damage related to rubs, abrasion, compression, or tension at the cables. Known methods and structures may utilize tie wraps, rolled foam, or hard plastic tubes, which may lead to undesired wear or rubbing at the cable. The outcome of such methods and structures may be dependent on the user, which allows for inconsistent results among users.

As such, methods and structures that reduce or mitigate wear, or furthermore reduce preparation time, of trays for splicing and cable routing would be advantageous. Furthermore, methods and structure that reduce inconsistency between users, or improve consistency between users, would be advantageous. Still further, improved organizer structures for use with closures would be advantageous. Specifically, organizer structures which address one of more of the above-stated deficiencies would be advantageous.

### BRIEF DESCRIPTION

Aspects and advantages of the invention will be set forth in part in the following description, or may be known from the description, or may be learned through practice of the invention.

An aspect of the present disclosure is directed to a fiber optic closure, the closure including a plurality of sidewalls extending along a longitudinal axis between a first end and a second end. The first end forms an open end such that a cable is extendable to or from an interior formed by the plurality of sidewalls. The closure includes a base wall extending from the plurality of sidewalls along the longitudinal axis and a lateral axis and an end wall extending along the lateral axis between the plurality of sidewalls. A bracket assembly extends along a transverse axis. The bracket assembly includes a main body and a plurality of hinge assemblies. The plurality of hinge assemblies is spaced apart in a linear array along the transverse axis. The main body is angled at 45 degrees or greater between a transverse axis and a longitudinal axis.

Another aspect of the present disclosure is directed to a fiber optic closure including a plurality of sidewalls extending along a longitudinal axis between a first end and a second end. The first end forms an open end such that a cable is extendable to or from an interior formed by the plurality of sidewalls. A base wall extends from the plurality of sidewalls along the longitudinal axis and a lateral axis. An end wall extends along the lateral axis between the plurality of sidewalls. A bracket assembly extends along a transverse axis. The bracket assembly includes a main body and a plurality of hinge assemblies. The plurality of hinge assemblies is spaced apart in a linear array along the transverse axis. The main body is angled at 45 degrees or greater between a transverse axis and a longitudinal axis. The closure includes an organizer tray including a tray main body. A pair of connector arms extends along the longitudinal axis toward the bracket assembly. A pin extends along the lateral axis between the pair of connector arms. The pin is configured to releasably attach to the bracket assembly in a third position, the third position between a first position substantially along the longitudinal axis and a second position at an angle between the transverse axis and the longitudinal axis greater than the third position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF FIGURES

A full and enabling disclosure of the present invention, including the best mode thereof, directed to one of ordinary skill in the art, is set forth in the specification, which makes reference to the appended figures, in which:

FIG. 1 is a perspective view of a closure in accordance with embodiments of the present disclosure;

FIG. 2 is a rear perspective view of an organizer assembly in accordance with embodiments of the present disclosure;

FIG. 3 is a rear perspective view of an organizer assembly, with organizer trays removed, in accordance with embodiments of the present disclosure;

FIG. 4 is a perspective view of the organizer assembly of FIG. 3 in accordance with embodiments of the present disclosure;

FIG. 5 is a perspective view of an organizer assembly, including an organizer tray in a third position installing into or removing from the bracket assembly, in accordance with embodiments of the present disclosure;

FIG. 6 is a perspective view of a portion of the organizer assembly of FIG. 5 in accordance with embodiments of the present disclosure;

FIG. 7 is a perspective view of the organizer assembly of FIG. 5 in accordance with embodiments of the present disclosure;

FIG. 8 is a perspective view of a portion of the organizer assembly of FIG. 5 in accordance with embodiments of the present disclosure;

FIG. 9 is a cross sectional view of a portion of an embodiment of the organizer assembly in a third position in accordance with embodiments of the present disclosure;

FIG. 10 is a cross sectional view of a portion of an embodiment of the organizer assembly in a second position in accordance with embodiments of the present disclosure;

FIG. 11 is a cross sectional side view of a portion of an embodiment of the organizer assembly in the second position in accordance with embodiments of the present disclosure;

FIG. 12 is a perspective view of a portion of an embodiment of the organizer assembly in accordance with embodiments of the present disclosure;

FIG. 13 is a cross sectional side view of an embodiment of the organizer assembly in accordance with embodiments of the present disclosure;

FIG. 14 is a perspective view of a portion of the organizer assembly, with organizer trays removed, in accordance with embodiments of the present disclosure;

FIG. 15 is a top-down view of a portion of the organizer assembly in accordance with embodiments of the present disclosure;

FIG. 16 is a close-up top-down view of the organizer assembly of FIG. 15 in accordance with embodiments of the present disclosure;

FIG. 17 is a perspective view of the organizer assembly of FIG. 15 in accordance with embodiments of the present disclosure;

FIG. 18 is a side view of the organizer assembly, including an organizer tray in the second position and a plurality of organizer trays in the first position, in accordance with embodiments of the present disclosure;

FIG. 19 is a perspective view of the organizer assembly, including a cover plate in a closed position, in accordance with embodiments of the present disclosure;

FIG. 20 is a rear perspective view of the organizer assembly, including the cover plate and organizer trays, in accordance with embodiments of the present disclosure;

FIG. 21 is a perspective view of the organizer assembly, including a cover plate in an open position, in accordance with embodiments of the present disclosure;

FIG. 22 is a perspective view of the organizer assembly, including the cover plate in a closed position, in accordance with embodiments of the present disclosure;

FIG. 23 is a perspective view of the organizer assembly, including the cover plate in an open position, in accordance with embodiments of the present disclosure;

FIG. 24 is a top-down view of the organizer assembly, including the cover plate in an open position, in accordance with embodiments of the present disclosure;

FIG. 25 is a top-down view of the organizer assembly, including the cover plate in a closed position, in accordance with embodiments of the present disclosure;

FIG. 26 is a perspective view of the organizer assembly, including a portion of the cover plate in the closed position, in accordance with embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Referring now to the figures, embodiments of closures 10 and organizer assemblies in accordance with the present disclosure are provided. Closures 10 in accordance with the present disclosure, and in particular the organizer assemblies and tray organizer assemblies, thereof, may advantageously provide improved routing features which reduce kinking and attenuation risks. Certain embodiments of closure 10 may form a butt closure or domed closure for fiber optic cable connections. Receptacles, such as closures 10, organizer baskets 110 or trays 200 thereof in accordance with the present disclosure may advantageously provide improved features for securing and positioning cables 42 at and through organizer trays and baskets in a variety of positions. Adapter structures, such as adapter 280, 380 provided herein, may advantageously allow efficient and effective fiber-populating, fiber splicing, improve cable routing consistency, allow for installation, implementation, and access of a variety of tray geometries to fit and rotate at the closure, or position the rotatable receptacles away such as to reduce kinking, binding, or interference of cables extending into and out of the receptacle.

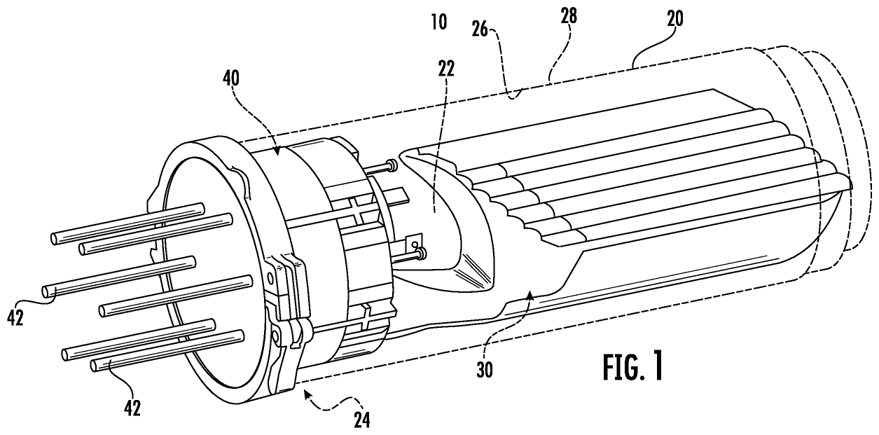

Referring now to FIG. 1, a closure 10 in accordance with the present disclosure includes a cover 20. Cover 20 is generally a domed cover which defines an interior 22 and an opening 24 which provides access to the interior 22. Cover 20 may include an inner surface 26 which defines the interior 22 and an opposing outer surface 28 which is exposed to the external environment.

An organizer assembly 30 may be insertable into (and thus disposed within) the interior 22, such as along a longitudinal axis of the closure 10. Organizer assembly 30 may include one or more organizer trays 200 and/or other suitable components for facilitating transmission component connections. For example, in the case of use with fiber optic cables, splices between optical fibers thereof may be housed in the various splice trays.

A base 40 may be insertable at least partially into (and thus disposed at least partially within) the interior 22. In some embodiments, organizer assembly 30 may be connected to the base 40, such that insertion of the base 40 causes insertion of the tray assembly 30 into the interior 22. Cables 42 may be inserted through the base 40 into the interior 22, and connection between transmission elements thereof (such as optical fibers) may be made within the interior 22, such as in the organizer trays 200 of the organizer assembly 30.

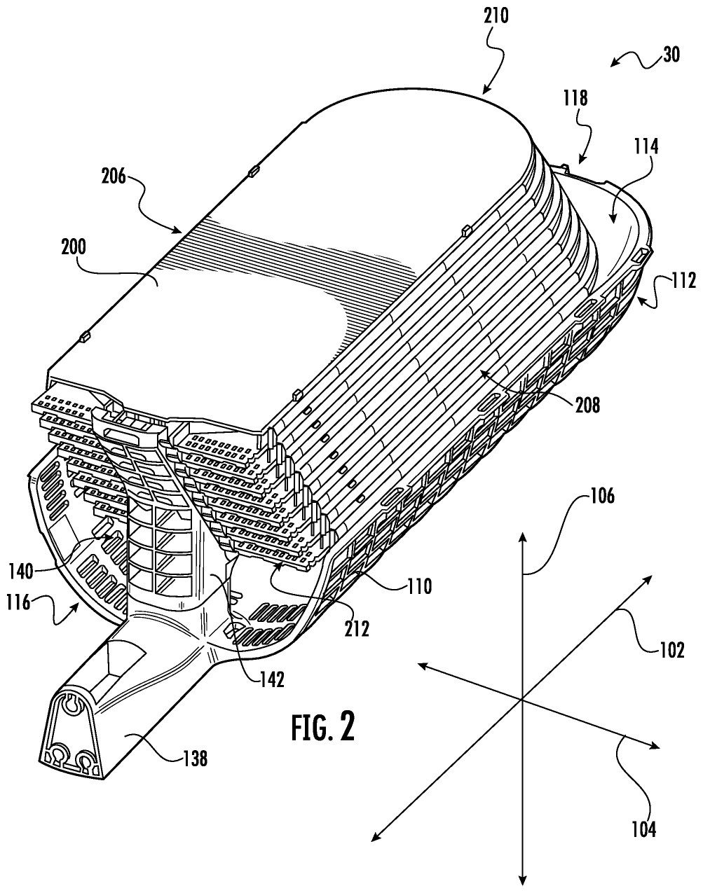

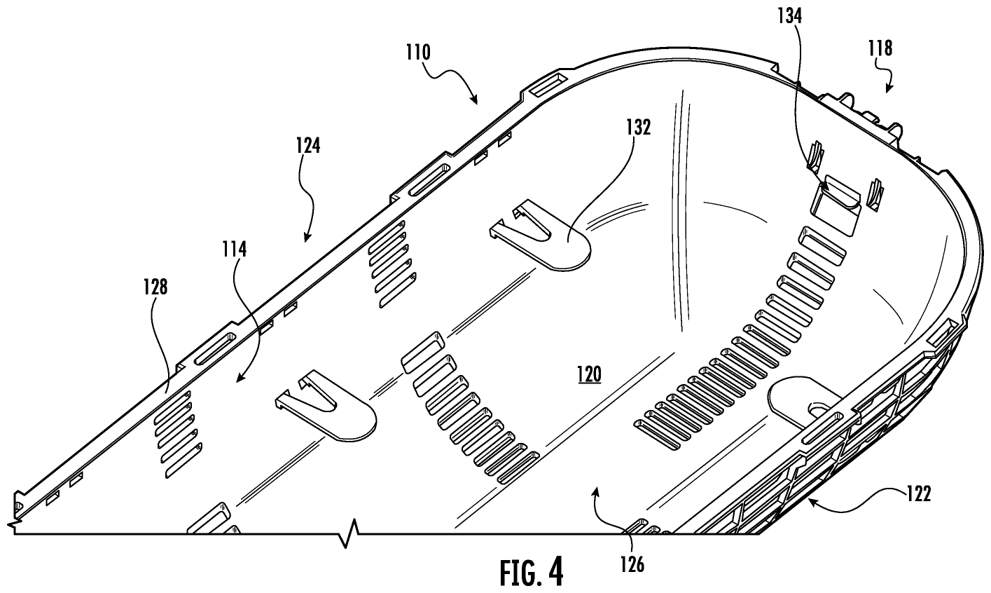

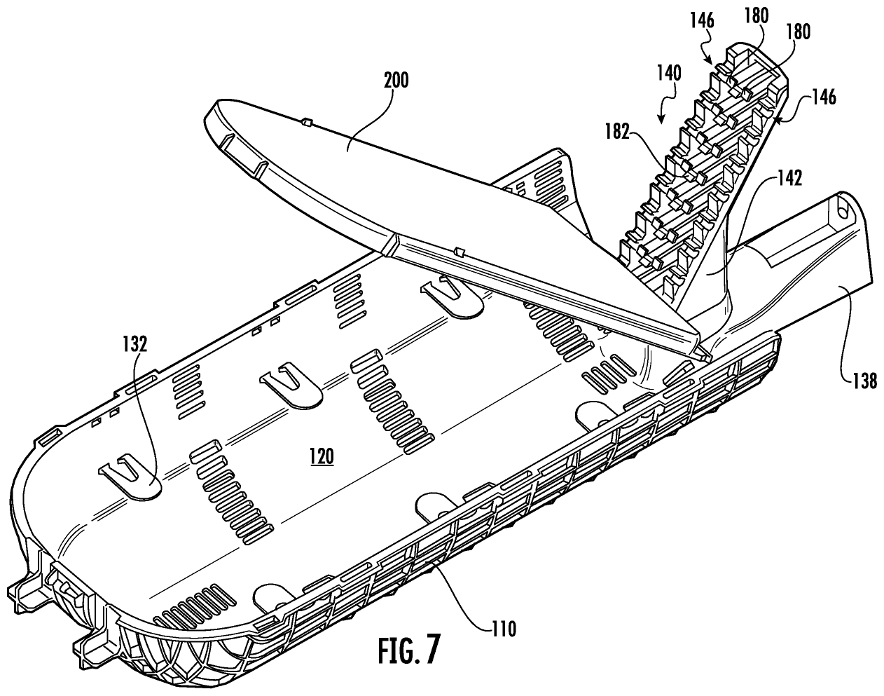

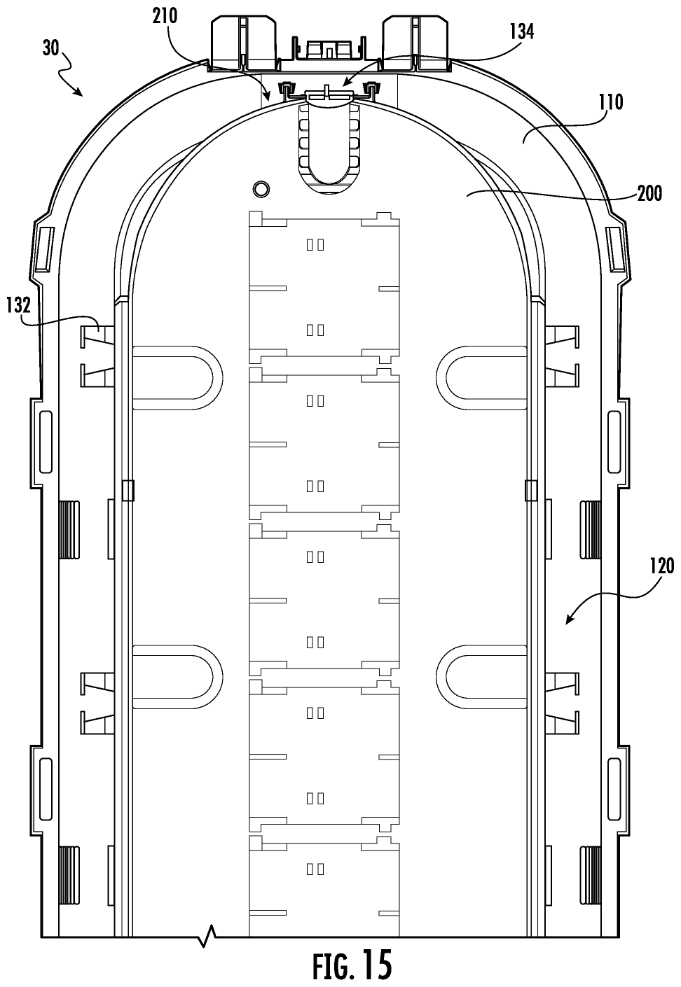

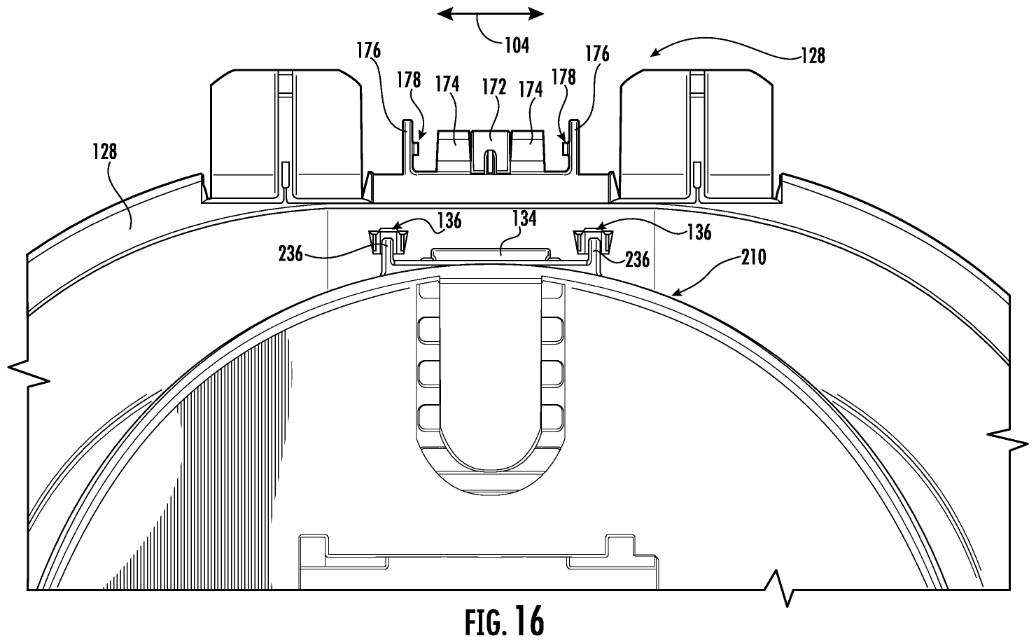

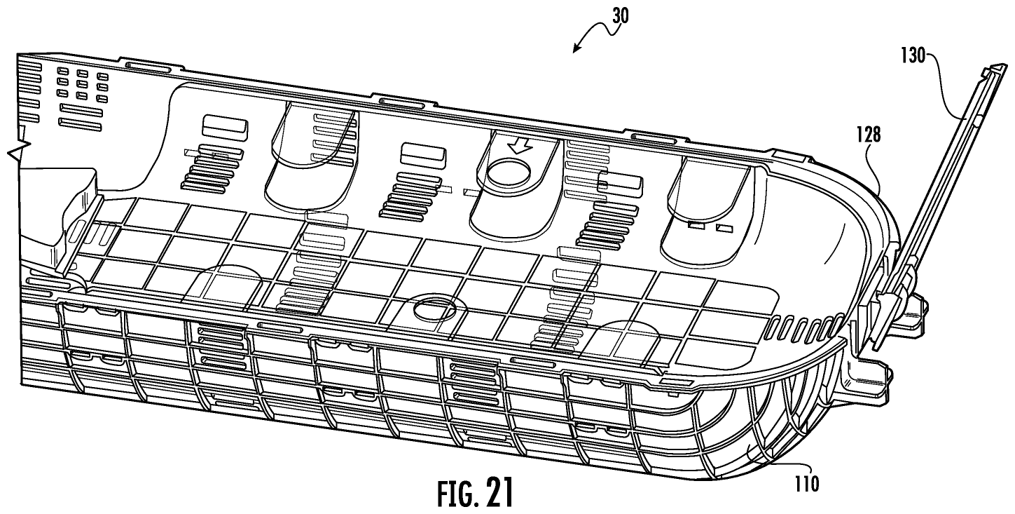

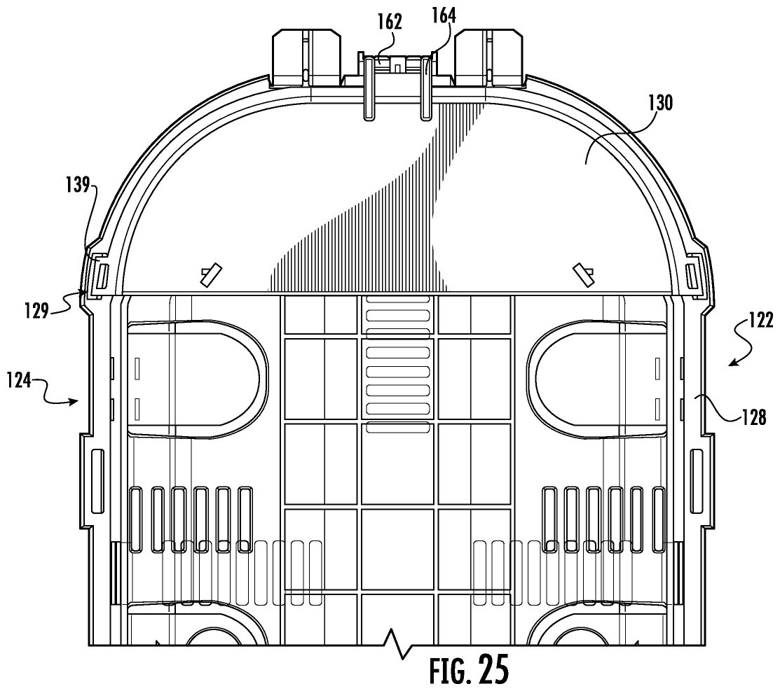

FIGS. 2 through 26 illustrate various embodiments of an organizer assembly 30 and components thereof in accordance with embodiments of the present disclosure. A mutually orthogonal coordinate system may be defined for organizer assembly 30 in accordance with the present disclosure, and may include a mutually orthogonal longitudinal axis 102, lateral axis 104, and transverse axis 106.

Referring to FIGS. 2-5, and in particular to FIG. 2, organizer assemblies 30 in accordance with the present disclosure may include a primary basket 110. The primary basket 110 generally forms at least a portion of the base exterior of the organizer assembly 30, and includes an exterior surface 112 and an interior surface 114. The primary basket 110 may extend along the longitudinal axis 102 between a first end 116 and a second end 118. The first end 116 may be an open end, as shown, such that cables 42 or transmission elements thereof being directed along and parallel to the longitudinal axis 102 can enter or exit an interior 120 of the primary basket 110 through the first end 116. The second end 118 may be a closed end, as shown, such that cables 42 (FIG. 1) or transmission elements thereof being directed along and substantially parallel to the longitudinal axis 102 cannot enter an interior 120 of the primary basket 110 through the second end 118, and instead encounter a surface of the primary basket 110.

The primary basket 110 may further extend along the lateral axis 104 between a first side 122 and a second side 124, both of which may be closed (as discussed above with respect to second end 118). In exemplary embodiments, a length between the first end 116 and second end 118 is greater than a length between the first side 122 and the second side 124. Further, in exemplary embodiments, transitions between the closed second end 118 portion and a base portion 126, the closed first side portion 122 and the base portion 126, the closed second side portion 124 and the base portion 126, the closed second end 118 portion and closed first side portion 122, and/or the closed second end 118 portion and closed second side portion 124 are curved.

Basket 110 may generally be utilized to house excess cables 42 and/or transmission elements thereof as the cables 42 and/or transmission elements thereof are routed through the closure 10 and organizer assembly 30 thereof.

Primary basket 110 may further include an upper peripheral lip 128, which may extend between the first end 116 and second end 118, such as on the sides 122, 124, and may further extend between the sides 122, 124, such as along the closed second end 118. For example, the lip 128 may extend along an upper edge (along the traverse axis 106) of the primary basket 110, such as along the sides 122, 124 and second end 118.

In some embodiments, basket 110 may further include a plurality of retainer tabs 132, each of which extends from the basket 110 into the interior 120. The tabs 132 may be connected to the basket 110 at the upper edge of the basket 110, such as adjacent the lip 128. Further, in exemplary embodiments, the tabs 132 are removable. In some embodiments, the tabs 132 may be connected to the basket 110 at interior surface 114 within interior 120. Tabs 132 may generally assist in routing and retaining cables 42 and transmission elements in the interior 120 during assembly, splicing, etc., thereof.

A connector shaft 138 may extend from the first end 116 along the longitudinal axis 102, such that at least a portion of the connector shaft 138 is exterior to the primary basket 110. The connector shaft 138 may connect to the base 40 (FIG. 1), thus connecting the organizer assembly 30 and base 40 together.

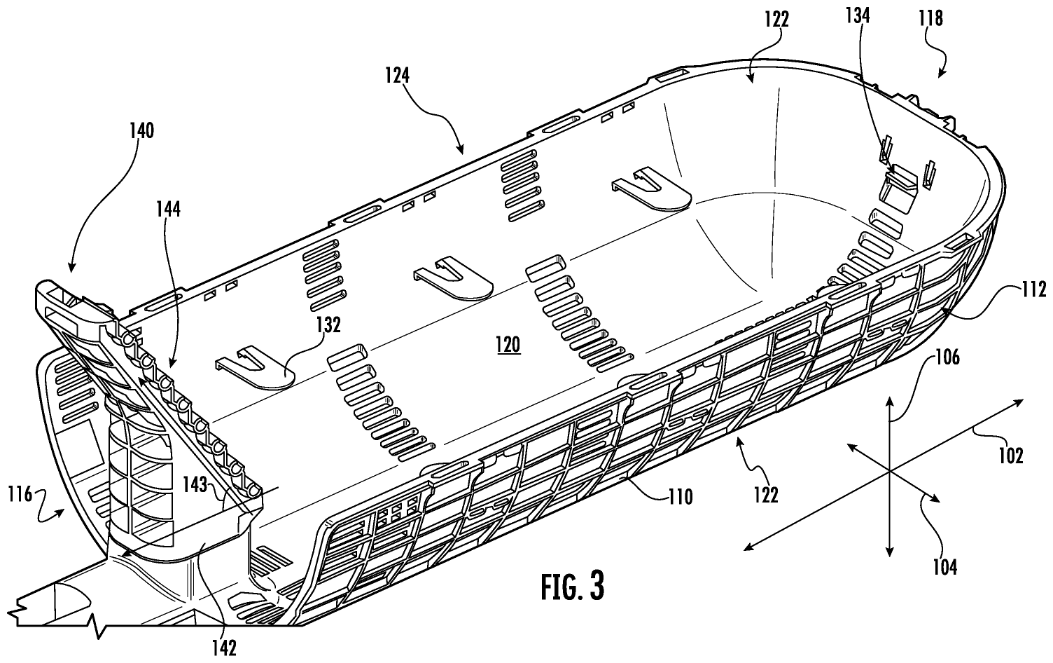

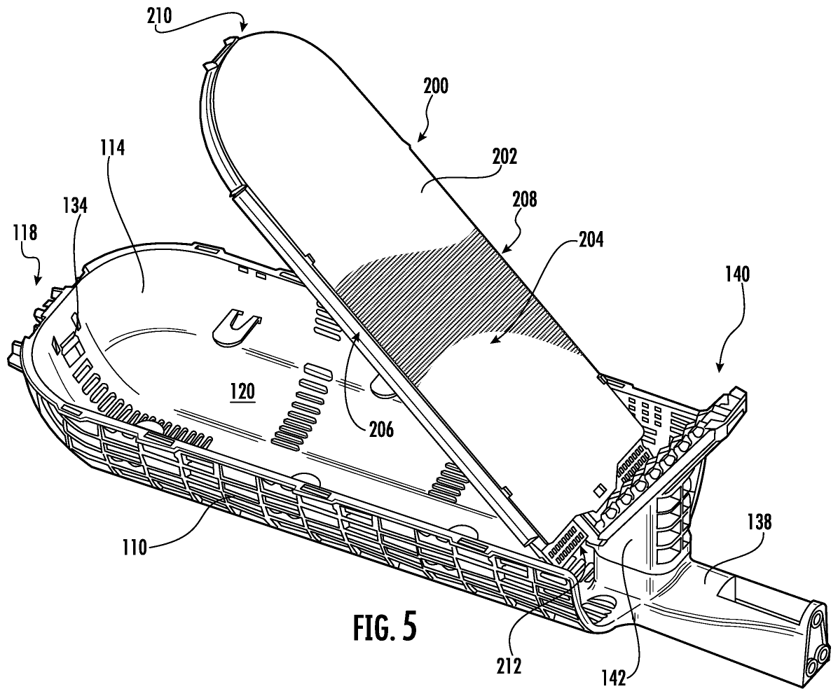

Referring now FIGS. 2-3, and in particular to FIGS. 5-8, a bracket assembly 140 may extend along the transverse axis 106 from the primary basket 110, such as at the first end 116. Bracket assembly 140 may include a main body 142 and a plurality of hinge assemblies 144. The hinge assemblies 144 may be spaced apart in a linear array along the transverse axis 106. In exemplary embodiments, the hinge assemblies 144 are stepped along the transverse axis 106. In these embodiments, the linear array of the hinge assemblies 144 is angled relative to the transverse axis 106, rather than being directed along or parallel to the transverse axis 106. At least the portion of the main body 142 which includes the hinge assemblies 144 may also be so angled. Such angle may be between the transverse axis 106 and the longitudinal axis 102, as shown. In particular, angle 143 is 45 degrees or greater relative to the longitudinal axis 102. In still particular embodiments, angle 143 is between approximately 70 degrees and 45 degrees, or between approximately 65 degrees and 45 degrees, or between approximately 60 degrees and 45 degrees. In a still particular embodiment, angle 143 is approximately 55 degrees, or within 50 degrees to 60 degrees. Particular ranges of angles provided herein advantageously allow for increased distance for routing optical fiber between the bracket assembly 140 and the basket 110.

Referring to FIGS. 2-3 and FIGS. 5-11, each hinge assembly 144 may include at least one positioning tab 180. Each hinge assembly 144 may further include at least one release tab 182. In some embodiments, for example, each hinge assembly 144 may include two positioning tabs 180 and a release tab 182, with the release tab 182 disposed between the positioning tabs 180 along the lateral axis 104. Each positioning tab 180 may be a generally tapered protrusion extending along the transverse axis 106 from the main body 142. Each release tab 182 may extend along the longitudinal axis 102 from the main body 142, and may thus protrude from the main body 142 farther than the positioning tab(s) 180 along the longitudinal axis 102.

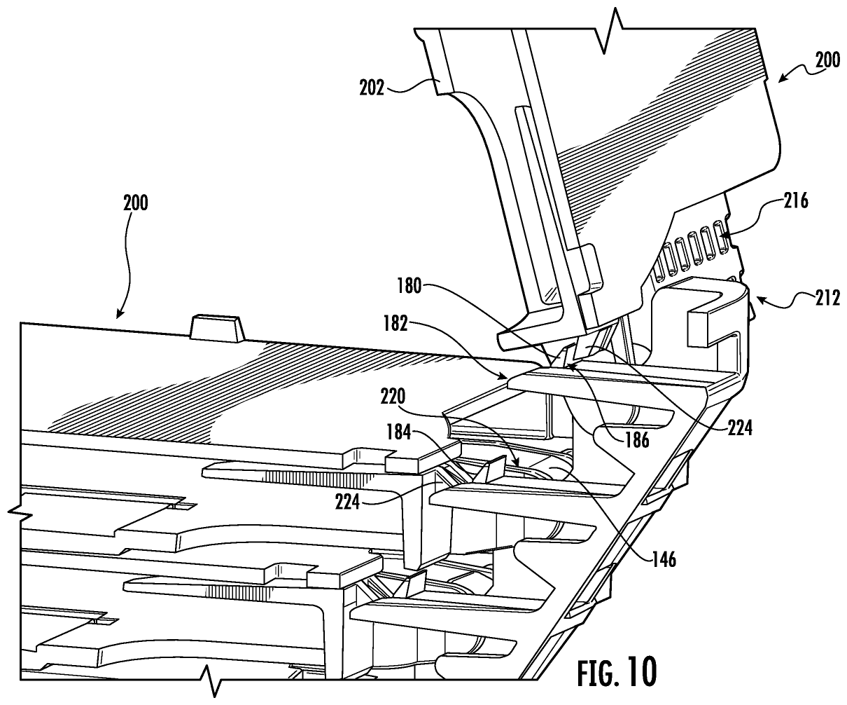

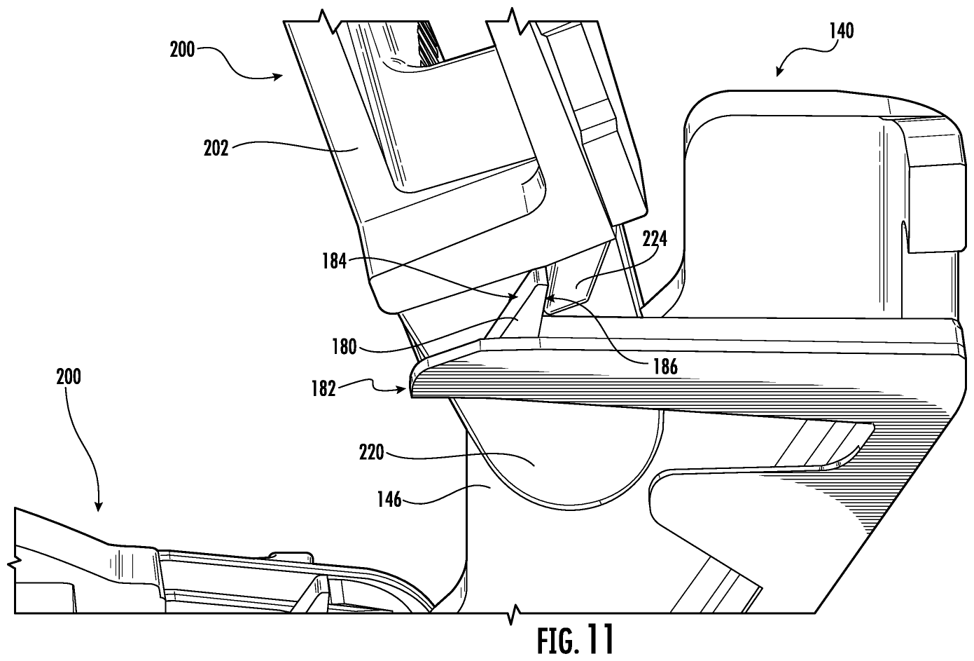

Referring now to FIGS. 5-17, organizer assemblies 30 in accordance with the present disclosure may further include one or more organizer trays 200. Each organizer tray 200 is rotatably connectable and removable, and thus may be rotatably connected, to the bracket assembly 140, such as to one of the plurality of hinge assemblies 144. Each organizer tray 200 may be rotatable, such as between a first position wherein the organizer tray 200 is aligned along the longitudinal axis 102 (such as shown in FIG. 2) and a second position wherein the organizer tray 200 is aligned along an angle between the transverse axis 106 and the longitudinal axis 102 (such as shown at FIGS. 10-11).

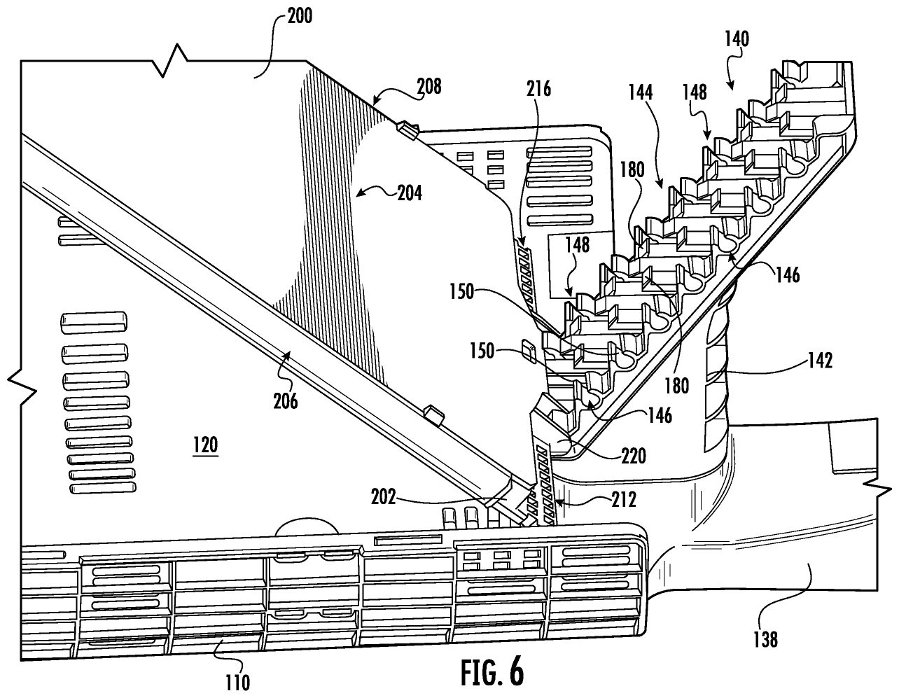

For example, as more clearly depicted in FIG. 2 and FIG. 6, each organizer tray 200 may include a tray main body 202. Tray main body 202 may, for example, include a base wall 204, a first sidewall 206, a second sidewall 208, and a front wall 210, and may further define a rear end 212. First sidewall 206 and second sidewall 208 may be spaced apart along the lateral axis 104. Front wall 210 and rear end 212 may be spaced apart (such as along the longitudinal axis 102 when in the first position). The rear end 212 may be an open end, as shown, such that cables 42 (FIG. 1) or transmission elements thereof being directed along and parallel to the longitudinal axis 102 can enter or exit an interior 214 of the organizer tray 200 through the rear end 212, when the organizer tray 200 is in the first position. The front wall 210 and sidewalls 206, 208 may define a closed end and closed sides.

In some embodiments, such as depicted more clearly in FIG. 6, a plurality of apertures 216 may be defined in the base wall 204, such as at the rear end 212. Each aperture 216 may be utilized to secure a cable 42 (FIG. 1) or transmission element directly to the base wall 204 and organizer tray 200 thereof, such as using a suitable zip-tie or other suitable fastener. Notably, in such embodiments, no additional cable/transmission element securement components are included on the organizer tray 200.

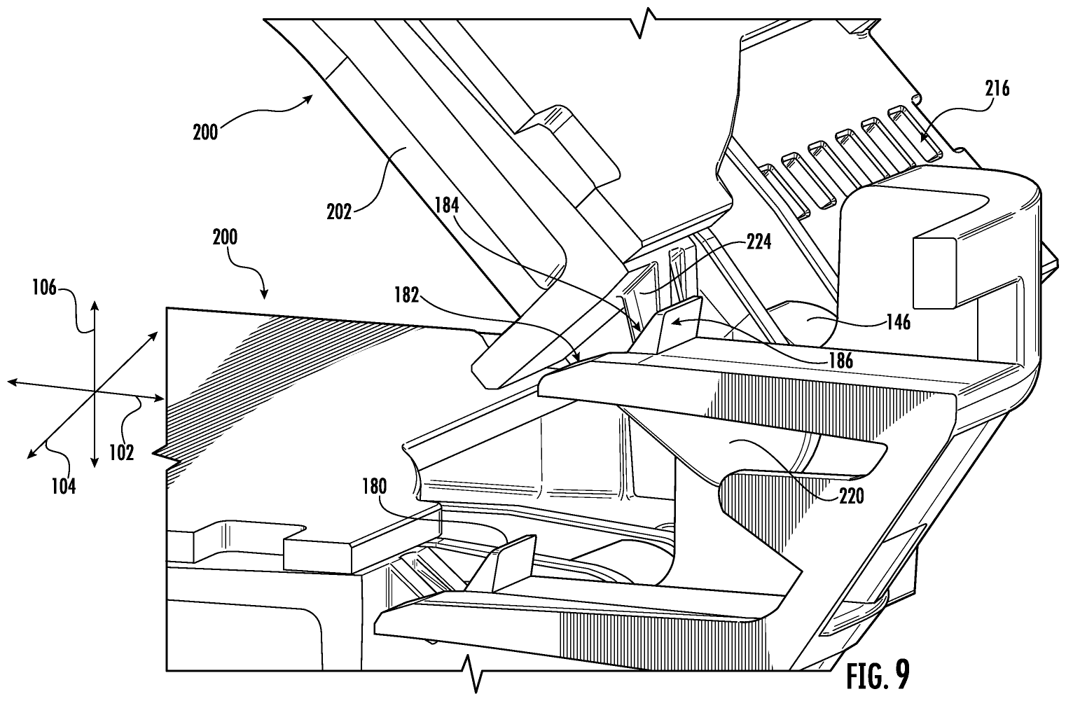

Referring now to FIGS. 5-11, and more particularly depicted in the cross sectional views provided in FIGS. 9-11, organizer tray 200 may further include one or more connector arms 220 which may extend from the tray main body 202. For example, each connector arm 220 may extend from the base wall 204, such as along the transverse axis 106 when in the first position. The connector arms 220 may be removably connected to the hinge assembly 144, thus rotatably connecting the organizer tray 200 thereto.

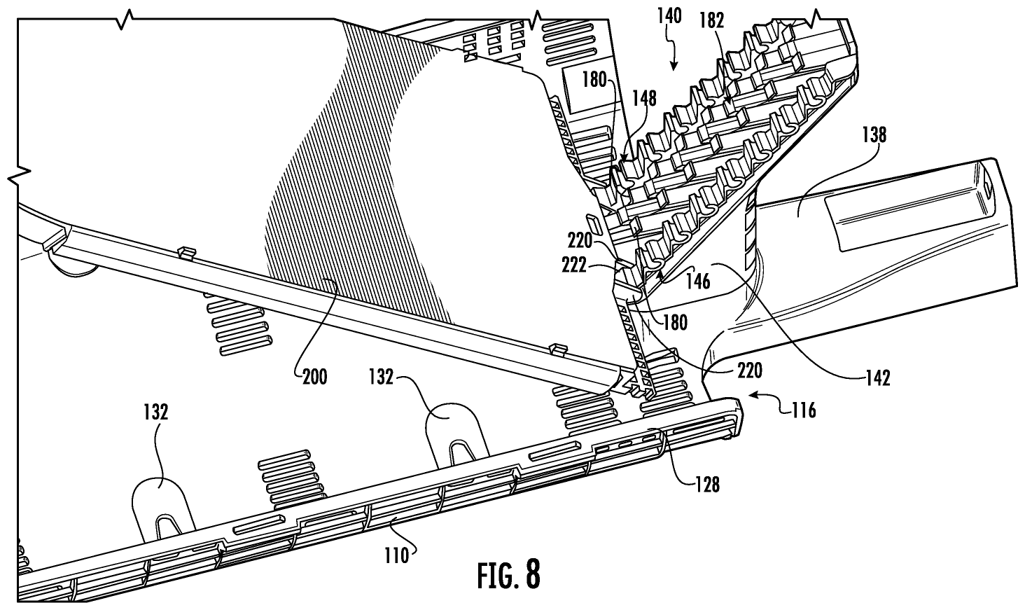

In particular embodiments, such as more clearly depicted in FIG. 8, organizer tray 200 includes a pin 222 extending between a pair of connector arms 220. Pin 222 is configured to position within channel 146 formed at hinge assembly 144. Channel 146 extends substantially along lateral axis 104. Pin 222 correspondingly extends along lateral axis 104 between pair of connector arms 220. In still particular embodiments, such as more clearly depicted in FIG. 6, main body 142 of hinge assembly 144 forms an arcuate opening 148 through which pin 222 is allowed into channel 146.

Referring still to FIG. 6, in certain embodiments, arcuate opening 148 includes faces 150 formed at opening 148 and extending from channel 146 to outside of the channel 146 or opening 148. In particular embodiments, faces 150 extend substantially flat, such as along a chord relative to a circular channel 146. Faces 150 may particularly extend away from one another, such as relative to a centerline through channel 146. A gap or arc between respective faces 150 is formed such as to allow pin 222 to slide through opening 148 and seat within channel 146. In still particular embodiments, opening 148 is formed within an arcuate sector between the transverse axis 106 and the longitudinal axis 102. In still particular embodiments, opening 148 forms a less than 90 degree opening, or a less than 85 degree opening, or a less than 80 degree opening, or a less than 75 degree opening. In further particular embodiments, opening 148 forms a greater than 30 degree opening, or a greater than 35 degree opening, or a greater than 40 degree opening, or a greater than 45 degree opening.

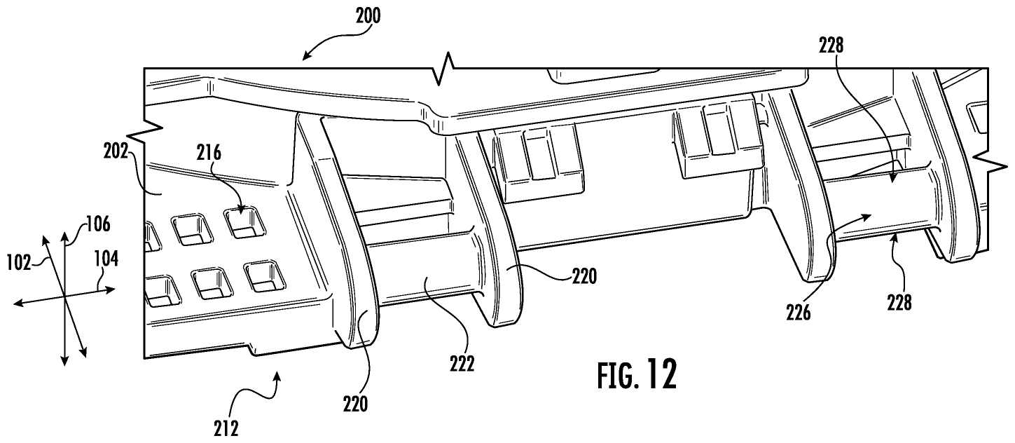

Referring now to FIG. 12, in particular embodiments, pin 222 includes a substantially flat face 228 and a rounded or curved face 226. In certain embodiments, flat faces 228 extend parallel to one another and are separated from one another relative to transverse axis 106. Curved face 226 extends substantially along transverse axis 106 between the flat faces 228. Flat faces 228 correspond substantially in dimension to an area between faces 150 at bracket assembly 140. Curved face 226 corresponds substantially to channel 146. Accordingly, faces 150 at the bracket assembly 140 may allow faces 228 at the organizer tray 200 to slid into channel 146. Curved face 226 may furthermore allow for rotation of pin 222 within channel 146 and desirably retain organizer tray 200 within channel 146, such as further described herein.

Embodiments of the attachment interface including pin 222 extending between connector arms 220 at the organizer tray 200 and the hinge assembly 144 forming channel 146 and opening 148 allow for greater strength over conventional attachment features. Additionally, or alternatively, the attachment interface provided herein allows for a third position at which the organizer tray 200 may be installed, or snapped into, or removed from, the hinge assembly 144 from an interim position between the first position (i.e., aligned along the longitudinal axis 102) and the second position (i.e., angled in an open position between the longitudinal axis 102 and the transverse axis 106).

As discussed, each of the plurality of organizer trays 200 may be rotatable between a first position substantially parallel to longitudinal axis 102 and a second position substantially along transverse axis 106 or an angle between axis 102 and axis 106. Further, each organizer tray 200 may advantageously be releasably securable in the second position, thus facilitating efficient loading of cables 42 (FIG. 1) and transmission elements thereof, splicing, etc., into other organizer trays 200 and the assembly 30 generally. The hinge assembly 144 which rotatable connects the organizer tray 200 to the bracket assembly 140 may releasably secure the organizer tray 200 in the second position.

For example, in exemplary embodiments as illustrated in FIGS. 9-11, the one or more positioning tabs 180 of the associated hinge assembly 144 may contact and releasably secure the organizer tray 200 in the second position. In some embodiments, the organizer tray 200 may include one or more contact tabs 224, each of which extends from the rear end 212 of the body 202. When the organizer tray 200 is moved to the second position, each contact tab 224 may contact a respective positioning tab 180 and releasably secure the organizer tray 200 in the second position. For example, each contact tab 224 may ride up a tapered front surface 184 of the positioning tab 180 and then rest in contact with a rear surface 186 of the positioning tab 180 when the organizer tray 200 reaches the second position.

In certain embodiments, arcuate opening 148 (FIGS. 6-8) is formed and extends such that pin 222 is allowed into channel 146 while contact tab 224 is proximate to front surface 184 and distal to rear surface 186 of positioning tab 180. For example, as organizer tray 200 is inserted into bracket 140 assembly at channel 146, particular ranges of arcuate opening 148 such as provided herein may require a user to slide pin 222 into channel 146 from an acute angle rather than parallel to longitudinal axis 102 or transverse axis 106. Accordingly, walls at which channel 146 is formed may prevent movement of pin 222 from leaving channel 146 when in the first position or the second position. In still further embodiments, arcuate opening 148 is formed relative to positioning tab 180 such as to form a third position at which organizer tray 200 may enter or exit channel 146. As provided above, the third position may particularly include an angular position between the transverse axis 106 and the longitudinal axis 102 such that contact tab 224 is proximate to front surface 184 and distal to rear surface 186.

In various embodiments, the third position is between approximately 10 degrees and approximately 70 degrees between the longitudinal axis 102 and the transverse axis 106. In particular embodiments, arcuate opening 148 corresponds to the angular range of the third position. Accordingly, in certain embodiments, arcuate opening 148 extends for an approximately 60 degree arc. In still various embodiments, the second position is less than 90 degrees and greater than approximately 60 degrees. In particular embodiments, the second position and the third position are non-overlapping ranges. For instance, embodiments at which the second position is greater than 60 degrees include the third position between 10 degrees and 60 degrees. In another instance, embodiments at which the third position is between 10 degrees and 70 degrees include the second position greater than 70 degrees. In still yet various embodiments, the first position is substantially horizontal or parallel to the longitudinal axis 102 (i.e., substantially zero degrees). In other embodiments, the first position may be less than 10 degrees. Accordingly, in various embodiments, the first position, the second position, and the third position each form non-overlapping ranges.

Further, in exemplary embodiments, after the organizer tray 200 is placed in the third position, the organizer tray may be rotated to the first position or the second position. In particular embodiments, the organizer tray 200 may be released from being secured in the second position to move from the second position to the first position. For example, movement of the release tab 182 may cause movement of the positioning tab(s) 180 out of contact with the organizer tray 200 (such as the contact tab(s) 224) thereof such that the organizer tray 200 can move from the second position to the first position. In exemplary embodiments, a user may apply force to the release tab 182 to cause such movement. For example, such force may pivot the release tab 182 and, due to a material connection between the release tab 182 and positioning tab(s) 180, also cause pivoting of the positioning tab(s) 180.

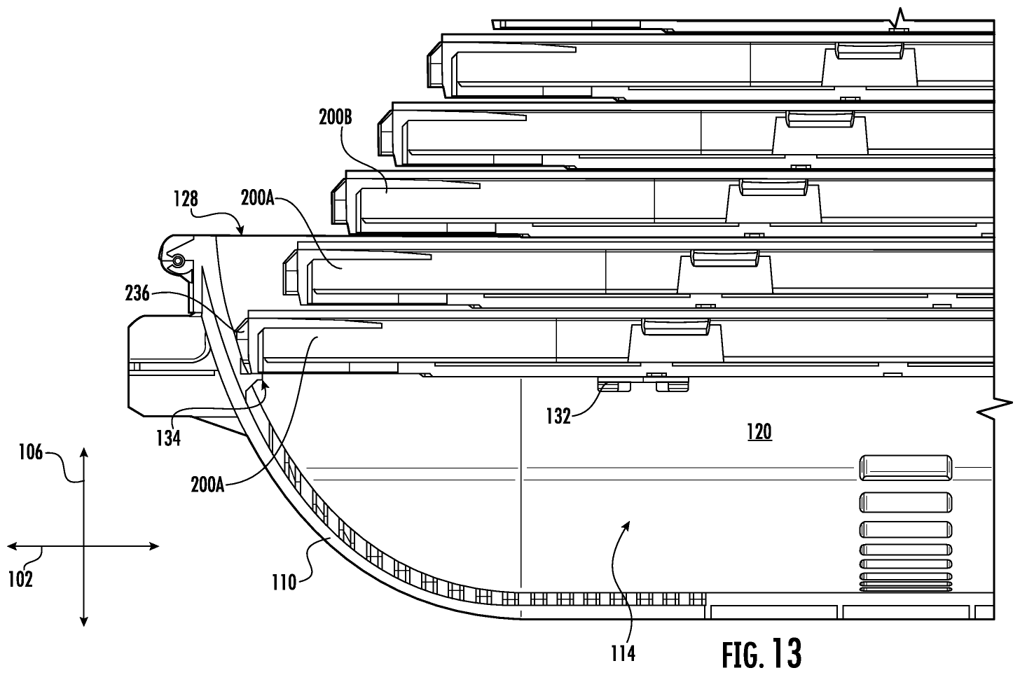

Referring now to FIG. 13, in an exemplary embodiment, one or more of the plurality of organizer trays 200 may rest in the first position and within interior 120 of organizer basket 110. In particular, one or more organizer trays, or particularly two or more organizer trays, such as depicted as organizer tray 200A, may rest in the first position and below lip 128 within interior 120 of basket 110. Tabs 132 extending from interior surface 114 below lip 128 may provide optical fiber slack retention features within interior 120. In some embodiments, tabs 132 may provide a support surface at which one or more of organizer tray 200A may rest within interior 120.

In particular embodiments, such as depicted in FIGS. 3-5 and FIGS. 13-14, basket 110 forms an end tab 134 at which one or more of organizer trays 200A may rest within the interior 120 in the first position. End tab 134 forms a platform extending substantially along the longitudinal axis 102 into interior 120 from second end 118 of basket 110. In certain embodiments, end tab 134 forms a primary support surface at which one or more organizer trays 200A is supported within interior 120.

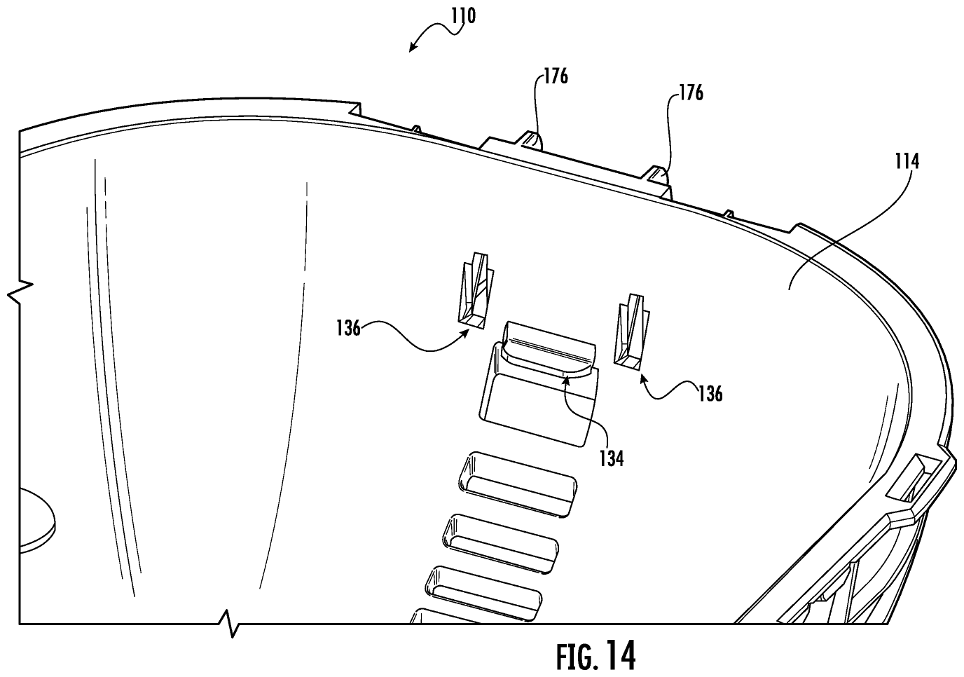

Referring to FIGS. 14-17, in certain embodiments, basket 110 forms a slot or opening 136 configured to receive a member 236 extending from the organizer tray 200. Member 236 extends substantially along the longitudinal axis 102 from the front wall 210 of the organizer tray 200. Opening 136 is configured to receive member 236 when organizer tray 200 is in the first position and is further configured to limit movement of the organizer tray 200 along the lateral axis 104.

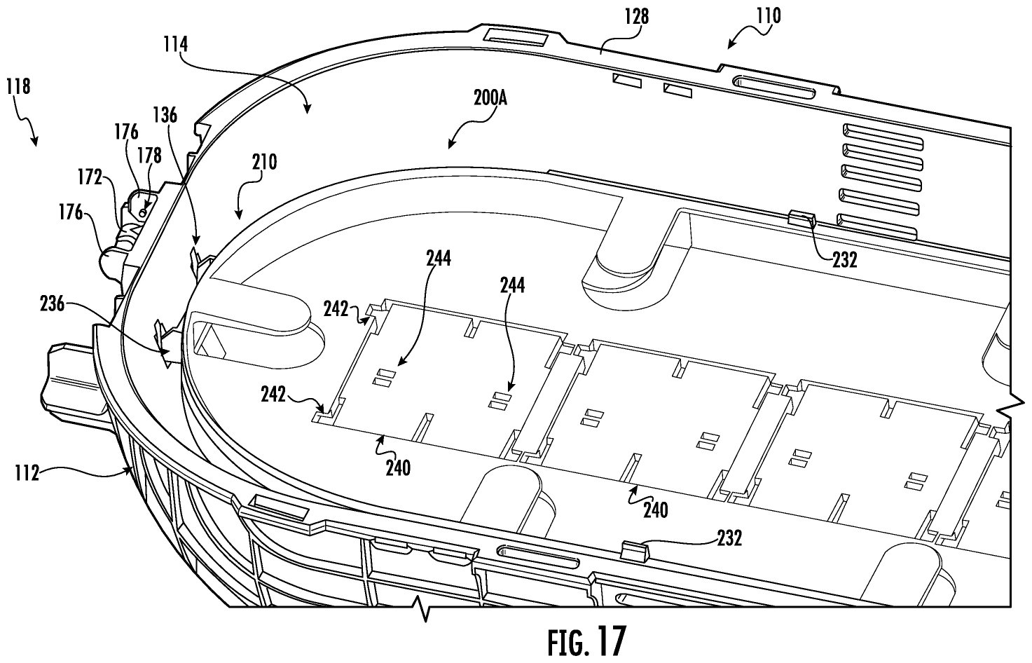

Referring back to FIG. 17, each organizer tray 200 may generally accommodate one or more splice modules. Each splice module may be removably connected to the organizer tray 200, such as to the base wall 204 thereof. For example, base wall 204 may include a plurality of module mounting locations 240. In exemplary embodiments, each of the module mounting locations 240 may include a plurality of leg slots 242 which may be defined through the base wall 204 and one or more pluralities of positioning slots 244 which may be defined through the base wall 204. The leg slots 242 may, for example, define at least a portion of a periphery of the module mounting location 240, and may for example, be disposed at corners of the module mounting location 240. Each plurality of positioning slots 244 may be defined within the periphery of the module mounting location 240, and may for example extend in a linear array. The leg slots 242 and positioning slots 244 may generally facilitate removable connection of a splice module to the organizer tray at a module mounting location 240.

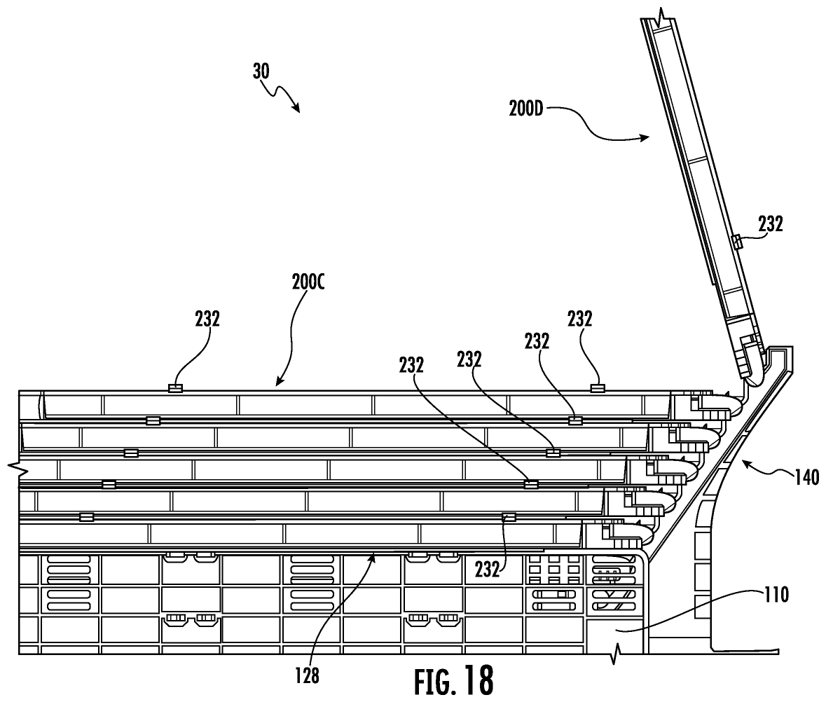

Referring now to FIG. 18, each organizer tray 200 may advantageously include features for ensuring and securing proper positioning of the organizer trays 200 relative to each other in the first and second positions. Advantageously, a positioning tab 232 of an organizer tray 200 may be positioned at a different longitudinal location along longitudinal axis 102 relative to neighboring organizer trays 200. For example, each organizer tray 200 may include one or more positioning tabs 232. The positioning tab 232 may extend from the first sidewall 206 and/or second sidewall 208, such as at a top of the organizer tray 200 opposite the base wall 204. The angled extension of the bracket assembly 140, such as described herein, allows each positioning tab 232 of respective organizer trays in the first position (organizer trays 200C) to be offset along the longitudinal axis 102 relative to neighboring organizer trays 200. One or more organizer trays may be rotated and locked into the second position (organizer trays 200D), such as depicted and described in regard to FIGS. 10-11.

FIG. 18 particularly depicts a quantity of six (6) organizer trays 200 positioned above lip 128. In certain embodiments, organizer assembly 30 further includes one or more organizer trays 200 positioned below lip 128, such as depicted and described in regard to FIG. 13. In particular embodiments, the organizer assembly 30 may receive organizer trays 200A within interior 120 of basket 110 and organizer trays 200B above lip 128 and stacked atop organizer trays 200A. In other embodiments, organizer trays 200A may be removed, allowing for additional fiber optic slack storage or other routing elements within the interior 120 of basket 110. Accordingly, certain embodiments of organizer assembly 30 may include a quantity of six (6) organizer trays 200B and a quantity of two (2) organizer trays 200A. However, it should be appreciated that other embodiments may include other quantities of organizer trays 200A, 200B. Furthermore, it should be appreciated that a single configuration of basket 110 and bracket assembly 140 may allow for such variations in configuration, allowing for greater variability of type of fiber optic cable, splices, and other operative elements at the organizer assembly 30.

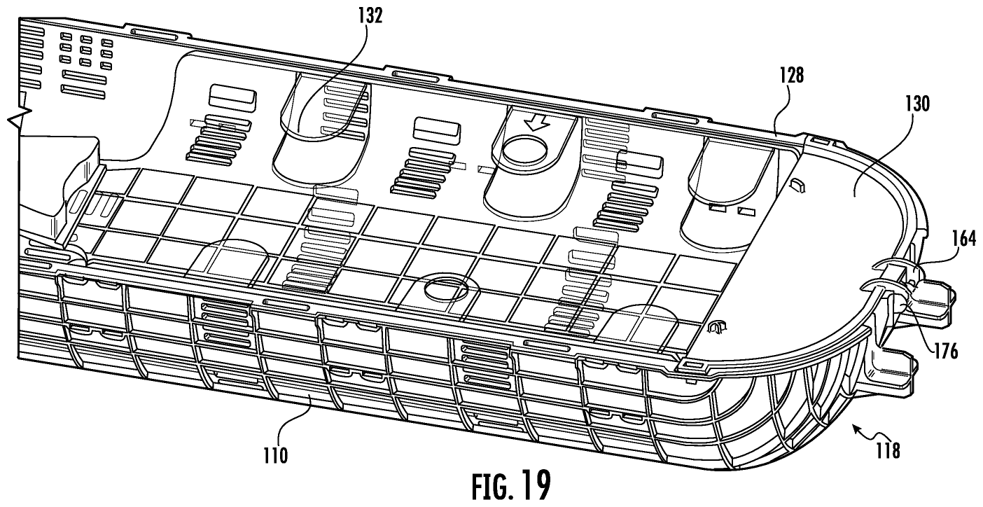

In some embodiments, as illustrated in FIGS. 19-26, a cover plate 130 may be provided. Cover plate 130 may be removably positioned on the basket 110, such as on the lip 128 thereof. Hook-and-loop fasteners or other suitable fastening apparatus may be utilized to removably fasten the cover plate 130 to the basket 110. Cover plate 130 may protect and help to secure portions of cables 42 (FIG. 1) and transmission elements thereof which are disposed in and routed through the interior 120 of basket 110. In certain embodiments, cover plate 130 may provide a platform or surface such as to support organizer trays 200B above lip 128.

In particular embodiments, cover plate 130 is attachable to basket 110 at the second end 118. Cover plate 130 extends from second end 118 of basket 110 toward the first end 116. In particular embodiments, cover plate 130 is configured to extend partially along a dimension of the interior 120 from second end 118 to first end 116. In particular, cover plate 130 may be configured to extend to provide a support surface for organizer trays 200B while allowing access to interior 120. In various embodiments, cover plate 130 includes a pin 162 extending along the lateral axis 104 between a pair of arms 164. Arms 164 extend from a plate main body 166 of cover plate 130. In particular, arms 164 extend along the longitudinal axis 102 toward the second end 118 of basket 110. When cover plate 130 is positioned onto basket 110, arms 164 extend outside of interior 120, such as to extend around lip 128 and proximate to exterior surface 112 and distal from interior surface 114.

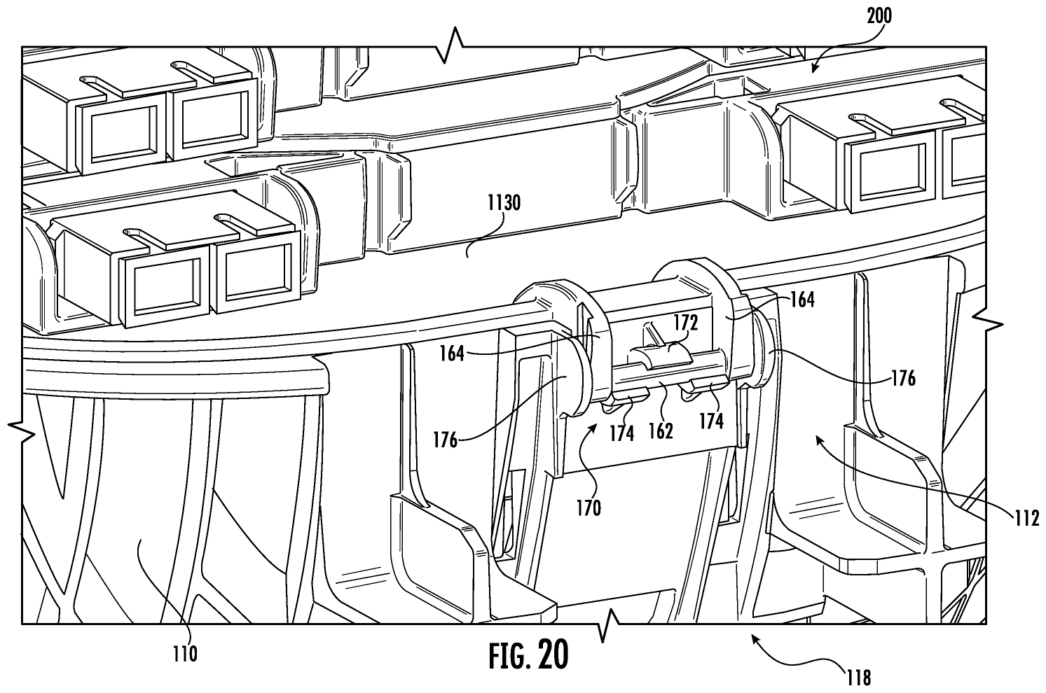

Referring still to FIGS. 19-26, and furthermore depicted in FIG. 17 and FIG. 20, in various embodiments, basket 110 forms a connector arm 176 extending from exterior surface 112 of basket 110. In particular, connector arm 176 extends from the second end 118 of the basket 110. Basket 110 may form a pair of connector arms 176 at which a respective pair of arms 164 of cover plate 130 may connect. Connector arms 176 may include a button or protrusion 178 providing a locating feature for respective arms 164 of the cover plate 130.

In still certain embodiments, basket 110 forms a first arcuate portion 172 and a second arcuate portion 174 forming a channel into which pin 162 at cover plate 130 may be positioned. First arcuate portion 172 and second arcuate portion 174 each form, at least in part, portions, of a circular pathway. In particular embodiments, arcuate portions 172, 174 are configured similarly as described in regard to hinge assembly 144 forming arcuate opening 148 and channel 146. In still particular embodiments, pin 162 at cover plate 130 is configured substantially similarly as pin 222 at organizer tray 200. Accordingly, pin 162 may include flat portions and curved portions corresponding to arcuate portions 172, 174 such as described in regard to flat faces 228 and curved faces 226 at pin 222.

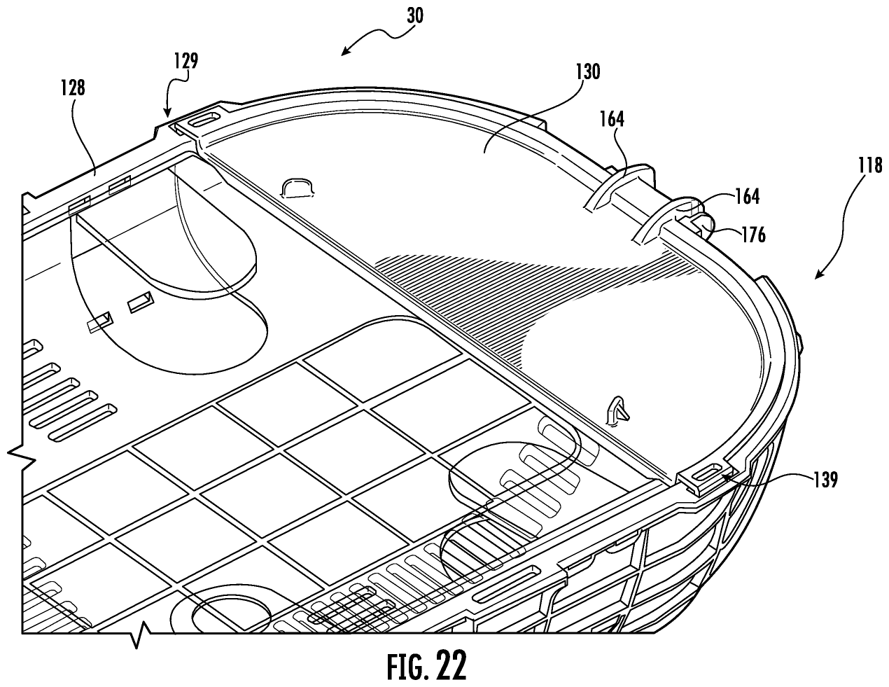

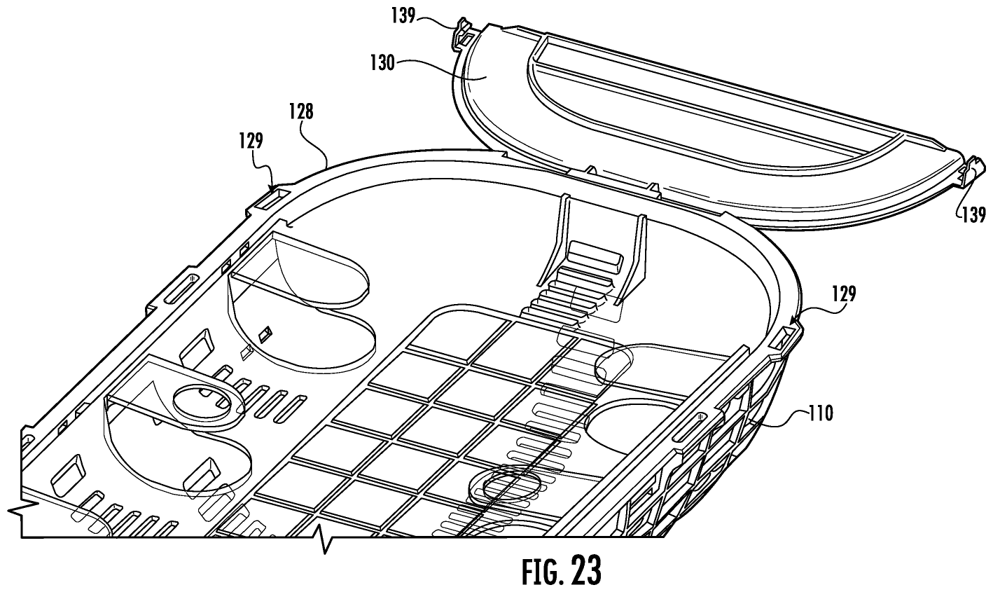

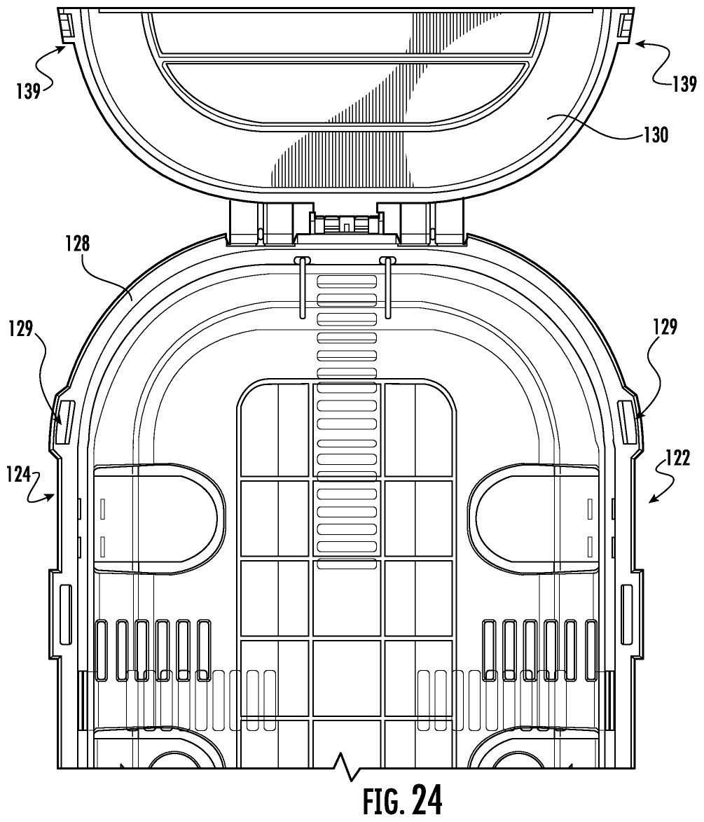

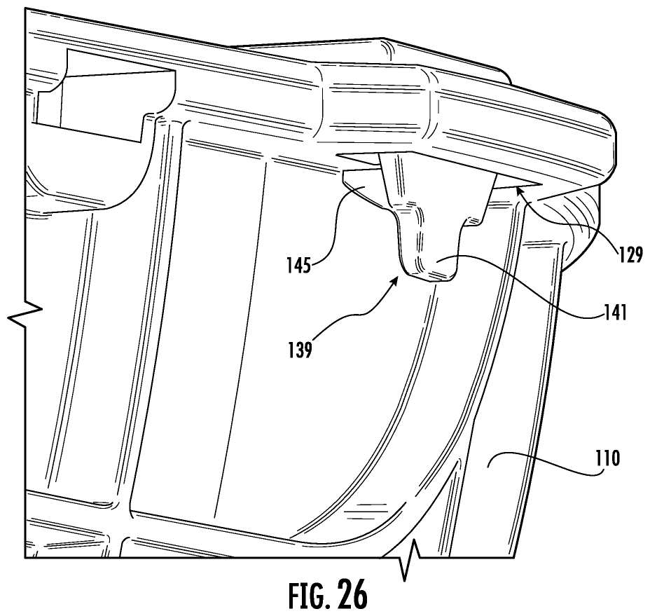

Referring now to FIGS. 22-26, basket 110 forms slots or openings 129 at lip 128. Opening 129 may particularly be formed at lip 128 or a platform extending from lip 128. In still particular embodiments, opening 129 is formed at lip 128 at the one or both of the first side 122 or second side 124 of basket 110. Cover plate 130 includes a tab 139 including a member 141 configured to extend into opening 129 at basket 110, such as along the transverse axis 106 into the opening 129 when cover plate 130 is rotated into a closed position (such as depicted in FIG. 22 and FIGS. 25-26). Referring to FIG. 26, in certain embodiments, tab 139 further includes a lock 145 extending toward exterior surface 122 when tab 139 is positioned through opening 129. Lock 145 may retain the tab 139 in the opening 129, allowing cover plate 130 to remain in the closed position. Tab 139, or particular portions thereof, such as, but not limited to, member 141 or lock 145, may be formed of a compliant material. Tab 139 including a compliant material may allow a user to bend the tab 139 to allow the lock 145 to move from interfacing with the basket 110, such as to allow tab 139 to egress through opening 129 to allow cover plate 130 to rotate into the open position (such as depicted in FIGS. 23-24).

In an exemplary embodiment of the closure 10 and organizer assembly 30, the organizer assembly 30 may include a quantity of six (6) second organizer trays 200B positioned at and above lip 128 and a quantity of two (2) first organizer trays 200A positioned within interior 120. The eight (8) organizer trays 200 allow for 6,912 fibers to be spliced with ribbon splices. Slack storage may be accommodated within interior 120 while further including the two (2) first organizer trays 200A.

In another exemplary embodiment of closure 10 and organizer assembly 30, the organizer assembly 30 may include a quantity of six (6) organizer trays 200B positioned at and above lip 128 while leaving interior 120 free of first organizer trays 200A. The six (6) organizer trays 200 allow for 864 single splices and utilizing the interior 120 for slack storage.

It should be appreciated that other embodiments may include any desired combination of ribbon splices, single splices, or other types or configurations of splices, modules, connectors, or other operational components for a fiber optic closure. Embodiments of the closure 10 and organizer assembly 30 provided herein allow for variations in fiber count, splice type, or other operative elements using a single configuration of basket 110 and bracket assembly 140.

Further aspects of the invention are provided by one or more of the following embodiments:

A fiber optic closure, the closure including a plurality of sidewalls extending along a longitudinal axis between a first end and a second end, wherein the first end forms an open end such that a cable is extendable to or from an interior formed by the plurality of sidewalls; a base wall extending from the plurality of sidewalls along the longitudinal axis and a lateral axis; an end wall extending along the lateral axis between the plurality of sidewalls; a bracket assembly extending along a transverse axis, the bracket assembly including a main body and a plurality of hinge assemblies, wherein the plurality of hinge assemblies is spaced apart in a linear array along the transverse axis, wherein the main body is angled at 45 degrees or greater between a transverse axis and a longitudinal axis.

2. The fiber optic closure of any one or more clauses herein, the plurality of hinge assemblies forming a channel extending along the lateral axis.

3. The fiber optic closure of any one or more clauses herein, wherein the plurality of hinge assemblies forms an arcuate opening into the channel.

4. The fiber optic closure of any one or more clauses herein, wherein the plurality of hinge assemblies forms an arcuate opening, the arcuate opening including faces extending substantially flat at a chord from the channel.

5. The fiber optic closure of any one or more clauses herein, including an organizer tray including a tray main body, wherein a pair of connector arms extends along the longitudinal axis toward the bracket assembly, and wherein a pin extends along the lateral axis between the pair of connector arms, the pin configured to releasably attach to the bracket assembly at the channel.

6. The fiber optic closure of any one or more clauses herein, wherein the organizer tray is configured to enter or egress into the channel at a third position, the third position between a first position substantially along the longitudinal axis and a second position at an angle between the transverse axis and the longitudinal axis greater than the third position.

7. The fiber optic closure of any one or more clauses herein, wherein the pin includes a pair of flat faces separated by a curved face and extending parallel to one another.

8. The fiber optic closure of any one or more clauses herein, wherein the fiber optic closure includes a plurality of organizer trays, the plurality of organizer trays including a first organizer tray positioned within the interior formed by the plurality of sidewalls, and wherein the fiber optic closure includes a second organizer tray positioned at or above a lip formed at the plurality of sidewalls.

9. The fiber optic closure of any one or more clauses herein, the fiber optic closure including two first organizer trays and one or more second organizer trays.

10. The fiber optic closure of any one or more clauses herein, the plurality of sidewalls forming an end tab at the second end, the end tab extending along the longitudinal axis from an interior surface of the plurality of sidewalls.

11. The fiber optic closure of any one or more clauses herein, the plurality of sidewalls forming a slot extending substantially along the transverse axis from the end tab.

12. The fiber optic closure of any one or more clauses herein, including a cover plate releasably attachable to the plurality of sidewalls, the cover plate rotatable between an open position and a closed position.

13. The fiber optic closure of any one or more clauses herein, the cover plate including a pair of arms extended along a longitudinal axis from a plate main body of the cover plate, the cover plate including a pin extending along a lateral axis between the pair of arms.

14. The fiber optic closure of any one or more clauses herein, the plurality of sidewalls including an arcuate portion forming a channel into at which the pin at the cover plate is rotatable.

15. A fiber optic closure, the closure including a plurality of sidewalls extending along a longitudinal axis between a first end and a second end, wherein the first end forms an open end such that a cable is extendable to or from an interior formed by the plurality of sidewalls; a base wall extending from the plurality of sidewalls along the longitudinal axis and a lateral axis; an end wall extending along the lateral axis between the plurality of sidewalls; a bracket assembly extending along a transverse axis, the bracket assembly including a main body and a plurality of hinge assemblies, wherein the plurality of hinge assemblies is spaced apart in a linear array along the transverse axis, wherein the main body is angled at 45 degrees or greater between a transverse axis and a longitudinal axis; and an organizer tray including a tray main body, wherein a pair of connector arms extends along the longitudinal axis toward the bracket assembly, and wherein a pin extends along the lateral axis between the pair of connector arms, the pin configured to releasably attach to the bracket assembly in a third position, the third position between a first position substantially along the longitudinal axis and a second position at an angle between the transverse axis and the longitudinal axis greater than the third position.

16. The fiber optic closure of any one or more clauses herein, wherein the plurality of hinge assemblies forms an arcuate opening at which a channel is formed, the arcuate opening and channel configured to receive and release the pin at the organizer tray in the third position, wherein the arcuate opening corresponds to the third position extending at the angle between approximately 10 degrees and approximately 70 degrees.

17. The fiber optic closure of any one or more clauses herein, wherein the organizer tray includes a contact tab extending from a rear end of the tray main body, and wherein the plurality of hinge assemblies includes a positioning tab forming a tapered front surface and a rear surface.

18. The fiber optic closure of any one or more clauses herein, wherein the arcuate opening at the plurality of hinge assemblies is configured to position the contact tab proximate to the front surface of the positioning tab and distal to the rear surface of the positioning tab when in the third position.

19. The fiber optic closure of any one or more clauses herein, the plurality of sidewalls forming an end tab at the second end, the end tab extending along the longitudinal axis from an interior surface of the plurality of sidewalls to support the organizer tray within the interior formed by the plurality of sidewalls.

20. The fiber optic closure of any one or more clauses herein, the organizer tray including a member extending along the longitudinal axis from a front wall of the tray main body of the organizer tray, and wherein the plurality of sidewalls forms a slot extending substantially along the transverse axis from the end tab, the slot configured to receive the member and limit movement along the lateral axis.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fiber optic closure, the closure comprising:
a plurality of sidewalls extending along a longitudinal axis between a first end and a second end, wherein the first end forms an open end such that a cable is extendable to or from an interior formed by the plurality of sidewalls;
a base wall extending from the plurality of sidewalls along the longitudinal axis and a lateral axis;
an end wall extending along the lateral axis between the plurality of sidewalls;
a bracket assembly extending along a transverse axis, the bracket assembly comprising a main body and a plurality of hinge assemblies, wherein the plurality of hinge assemblies is spaced apart in a linear array along the transverse axis, wherein the main body is angled at 45 degrees or greater between a transverse axis and a longitudinal axis.

2. The fiber optic closure of claim 1, the plurality of hinge assemblies forming a channel extending along the lateral axis.

3. The fiber optic closure of claim 2, wherein the plurality of hinge assemblies forms an arcuate opening into the channel.

4. The fiber optic closure of claim 2, wherein the plurality of hinge assemblies forms an arcuate opening, the arcuate opening comprising faces extending substantially flat at a chord from the channel.

5. The fiber optic closure of claim 2, comprising:
an organizer tray comprising a tray main body, wherein a pair of connector arms extends along the longitudinal axis toward the bracket assembly, and wherein a pin extends along the lateral axis between the pair of connector arms, the pin configured to releasably attach to the bracket assembly at the channel.

6. The fiber optic closure of claim 5, wherein the organizer tray is configured to enter or egress into the channel at a third position, the third position between a first position substantially along the longitudinal axis and a second position at an angle between the transverse axis and the longitudinal axis greater than the third position.

7. The fiber optic closure of claim 5, wherein the pin comprises a pair of flat faces separated by a curved face and extending parallel to one another.

8. The fiber optic closure of claim 5, wherein the fiber optic closure comprises a plurality of organizer trays, the plurality of organizer trays comprising a first organizer tray positioned within the interior formed by the plurality of sidewalls, and wherein the fiber optic closure comprises a second organizer tray positioned at or above a lip formed at the plurality of sidewalls.

9. The fiber optic closure of claim 8, the fiber optic closure comprising two first organizer trays and one or more second organizer trays.

10. The fiber optic closure of claim 1, the plurality of sidewalls forming an end tab at the second end, the end tab extending along the longitudinal axis from an interior surface of the plurality of sidewalls.

11. The fiber optic closure of claim 10, the plurality of sidewalls forming a slot extending substantially along the transverse axis from the end tab.

12. The fiber optic closure of claim 1, comprising:
a cover plate releasably attachable to the plurality of sidewalls, the cover plate rotatable between an open position and a closed position.

13. The fiber optic closure of claim 12, the cover plate comprising a pair of arms extended along a longitudinal axis from a plate main body of the cover plate, the cover plate comprising a pin extending along a lateral axis between the pair of arms.

14. The fiber optic closure of claim 13, the plurality of sidewalls comprising an arcuate portion forming a channel into at which the pin at the cover plate is rotatable.

15. A fiber optic closure, the closure comprising:
a plurality of sidewalls extending along a longitudinal axis between a first end and a second end, wherein the first end forms an open end such that a cable is extendable to or from an interior formed by the plurality of sidewalls;
a base wall extending from the plurality of sidewalls along the longitudinal axis and a lateral axis;
an end wall extending along the lateral axis between the plurality of sidewalls;
a bracket assembly extending along a transverse axis, the bracket assembly comprising a main body and a plurality of hinge assemblies, wherein the plurality of hinge assemblies is spaced apart in a linear array along the transverse axis, wherein the main body is angled at 45 degrees or greater between a transverse axis and a longitudinal axis; and
an organizer tray comprising a tray main body, wherein a pair of connector arms extends along the longitudinal axis toward the bracket assembly, and wherein a pin extends along the lateral axis between the pair of connector arms, the pin configured to releasably attach to the bracket assembly in a third position, the third position between a first position substantially along the longitudinal axis and a second position at an angle between the transverse axis and the longitudinal axis greater than the third position.

16. The fiber optic closure of claim 15, wherein the plurality of hinge assemblies forms an arcuate opening at which a channel is formed, the arcuate opening and channel configured to receive and release the pin at the organizer tray in the third position, wherein the arcuate opening corresponds to the third position extending at the angle between approximately 10 degrees and approximately 70 degrees.

17. The fiber optic closure of claim 16, wherein the organizer tray comprises a contact tab extending from a rear end of the tray main body, and wherein the plurality of hinge assemblies comprises a positioning tab forming a tapered front surface and a rear surface.

18. The fiber optic closure of claim 17, wherein the arcuate opening at the plurality of hinge assemblies is configured to position the contact tab proximate to the front surface of the positioning tab and distal to the rear surface of the positioning tab when in the third position.

19. The fiber optic closure of claim 15, the plurality of sidewalls forming an end tab at the second end, the end tab extending along the longitudinal axis from an interior surface of the plurality of sidewalls to support the organizer tray within the interior formed by the plurality of sidewalls.

20. The fiber optic closure of claim 19, the organizer tray comprising a member extending along the longitudinal axis from a front wall of the tray main body of the organizer tray, and wherein the plurality of sidewalls forms a slot extending substantially along the transverse axis from the end tab, the slot configured to receive the member and limit movement along the lateral axis.
